(19) United States
(12) Patent Application Publication
(10) Pub. No.: US 2026/0172960 A1
(43) Pub. Date: Jun. 18, 2026

(54) METHOD FOR MANAGING THE ENERGY CONSUMPTION OF WIRELESS COMMUNICATION INTERFACES OF AN ACCESS-POINT ELECTRONIC DEVICE, CORRESPONDING ACCESS-POINT ELECTRONIC DEVICE AND COMPUTER PROGRAM

(71) Applicant: SAGEMCOM BROADBAND SAS, Bois-Colombes (FR)

(72) Inventor: Massinissa LALAM, Bois-Colombes (FR)

(73) Assignee: SAGEMCOM BROADBAND SAS, Bois-Colombes (FR)

(21) Appl. No.: 19/409,348

(22) Filed: Dec. 4, 2025

(30) Foreign Application Priority Data
Dec. 17, 2024 (FR) 2414360

(51) Int. Cl. H04W 52/02; H04W 28/02

(52) U.S. Cl. CPC H04W 52/0203; H04W 28/0284; H04W 52/028

(57) ABSTRACT

A method for managing an energy consumption of a network gateway including at least one interface for communicating to a local communication network. The management method includes: on detection of a congestion, determining whether at least one station is connected thereto, and, if at least one station is connected, then detecting a first communication stream via said communication interface, between the wide area network and said local area network, on the one hand, and a second communication stream, between several stations connected to the local area network, on the other hand, then: when a first communication stream is present, or when a second communication stream is present a throughput of which is below a predetermined throughput threshold, modifying an initial configuration of the communication interface in question to reduce its energy consumption, and otherwise maintaining its initial configuration.

### TECHNICAL FIELD

The present disclosure relates to the field of communication networks, and in particular wireless local communication networks. Such wireless local communication networks generally comprise one or more electronic devices of the access point (AP) type, such as communication network gateways. More particularly, the present disclosure relates to the management of the energy consumption of these communication network gateways and in particular of the interfaces of these gateways for communicating to a local communication network.

### PRIOR ART

In a residential or work environment, a so-called “access point” (AP) electronic device is typically a communication network gateway, or network gateway, for example a box provided by an internet operator. Generally, such an access-point electronic device comprises at a minimum a wireless communication interface or radio interface or radio resource (these terms being used indifferently hereinafter), allowing the establishment of local communications of the wireless type in accordance, for example, with one of the standards in the 802.11 family of standards of the Institute of Electrical and Electronics Engineers (known by the acronym “IEEE”), or so-called “Wi-Fi” networks. The terms “wireless communication interface” or “radio resource” or “radio interface” here designate an electronic physical interface configured to implement bidirectional wireless communications between one or more compatible remote stations and a local or wide area communication network, for example in accordance with a protocol of the 802.11 family of standards of the IEEE, and/or between the stations.

Such stations are, for example, user devices such as: computers, televisions, tablets or so-called “smart” telephones (or “smartphones”), etc, or other electronic devices of the access-point type such as electronic equipment forming a system for extending wireless communication coverage (e.g. Wi-Fi extender, wireless repeater, etc).

At the present time, more and more frequency bands are being used in the context of wireless communications in order to respond to the increasing need for data consumption. In general, by default, all radio interfaces are switched on, whether or not there are stations connected to one of them. Consequently, the increase in radio interfaces within the network gateway poses a real problem of energy consumption thereof. It should be noted that radio interfaces operating at 5 GHz or 6 GHz use a particularly large amount of electrical energy.

Conventionally, one solution for reducing the energy consumption of a radio interface is to keep it switched on but in a degraded mode (e.g. several transmission/reception chains are switched off). It is thus possible to reduce the energy consumption of the radio interface while keeping its ability to detect demands for connection to stations. The drawback of this approach is that it is certainly possible to reduce the total energy consumption of the network gateway (in particular if the radio interface is operating at 5 GHz or 6 GHz), but these energy savings then take place mainly only when no station is connected to the radio interfaces of the network gateway (the typical condition of triggering such a mechanism).

It is therefore desirable to overcome this drawback of the prior art. In particular, there is a need to improve the electrical energy consumption of the network gateway.

### DISCLOSURE

It is in particular desirable to provide a solution that makes it possible to benefit from a congestion phenomenon taking place on a connection between an access-point electronic device of the network gateway type and a wide-area communication network, to save on energy at its interfaces for communicating to a local communication network.

For these purposes, a method is proposed here for managing an energy consumption of a network gateway comprising at least one first interface for communication with a wide-area communication network and at least one second interface for communication to a local communication network. This management method comprises: on detection of a congestion of said first communication interface, determining, for each second communication interface, whether at least one station is connected to said second communication interface in question, and, for said second communication interface in question to which at least one station is connected, detecting a first communication stream via said second communication interface in question, between said wide area network and said local area network, on the one hand, and a second communication stream, via said second communication interface in question, between several stations connected to said local area network, on the other hand, then: either when a first communication stream via said second communication interface in question is present, between said wide area network and said local network, or when a second communication stream, via said second communication interface in question, is present, between several stations connected to said local area network, and, if the throughput of said second communication stream is below a predetermined throughput threshold (S1), then modifying an initial configuration of said second communication interface in question to reduce its energy consumption, and otherwise maintaining its initial configuration.

Thus it is possible to take advantage of a phenomenon of congestion of a communication interface of a network gateway, configured to allow bidirectional communication between the network gateway and a wide-area communication network of the WAN type. In particular, it is possible to benefit from this congestion phenomenon, to reduce the energy consumption of the communication interfaces of the radio interface type, of the network gateway, configured to allow access to one or more local communication networks LAN (“Local Area Network”). This is because, since the communication interface of the network gateway with the wide area network is limited because of congestion, it is then not necessary to operate the radio communication interfaces of the gateway with a local communication network at the maximum of their communication capacity when they make streams pass between the local area network and the wide area network.

In a particular embodiment, the method furthermore comprises: performing an action of managing an energy consumption of said second communication interface in question, when no station is connected to said second communication interface in question.

According to a particular embodiment, performing said action of managing an energy consumption of said second communication interface in question comprises: switching off said second communication interface in question.

According to a particular embodiment, the management method furthermore comprises: when said configuration of said second communication interface in question has been modified, then checking whether said congestion is still detected and, when said congestion is still detected, determining whether a use of an antenna time by said second communication interface in question is greater than or equal to a predetermined antenna-time threshold, and, when said use of the antenna time by said second communication interface in question is greater than or equal to the predetermined antenna-time threshold, then restoring said initial configuration of said second communication interface in question.

Advantageously, if the communication capacities of a communication interface with a local communication network of the network gateway are reduced and a use of antenna time (i.e. time taken to transmit and receive information intended for the local area network or coming from the local area network) of this communication interface is greater than or equal to a predetermined antenna-time threshold, then it is possible to restore the communication capacities of this communication interface with a local communication network.

According to a particular embodiment, the method furthermore comprises:
when said configuration of said second communication interface in question has been modified, then checking whether said congestion is still detected and, when said congestion is no longer detected, restoring said initial configuration of said second communication interface in question.

Advantageously, when the communication interface of the network gateway with the wide area network is no longer suffering congestion, it is possible to re-establish the communication capacities of the communication interfaces with a local communication network of the network gateway.

According to a particular embodiment, modifying an initial configuration of said second communication interface in question comprises: comparing a frequency band on which said second communication interface in question is operating with a frequency band on which at least one other second communication interface is operating, and, if said frequency band on which said second communication interface in question is operating is higher than said frequency band on which said at least one other second communication interface is operating, then modifying the initial configuration of said second communication interface in question as a priority, otherwise modifying an initial configuration of said other second communication interface as a priority.

Advantageously, when several communication interfaces with a local communication network of the network gateway are connected to one or more stations and when furthermore there is network traffic between these stations and the wide area network via these communication interfaces with a local communication network or when a communication stream exists in a wireless communication network made available by these communication interfaces with a local communication network, then the communication capacities of the communication interfaces with a local communication network are reduced in accordance with a priority mechanism taking into account the frequency band on which each of the communication interfaces with a local communication network is operating. The communication interface with a local communication network operating on the highest frequency band among a set of communication interfaces with a local communication network will have its communication capacities reduced as a priority. It is thus possible to reduce the energy consumption of the network gateway by first reducing the communication capacities of the communication interfaces with a local communication network that are consuming the most energy (i.e. those operating on the highest frequency bands, for example 5 GHz and 6 GHZ).

According to a particular embodiment, modifying an initial configuration of said second communication interface in question comprises one or other or a combination of the following modifications:
reducing a width of an operational channel of said second communication interface in question,
reducing a number of transmission chains of said second communication interface in question,
reducing a number of reception chains of said second communication interface in question,
reducing a transmission power of said second communication interface in question.

A module for managing an energy consumption of at least one second communication interface to a local communication network of a network gateway is also proposed here, said network gateway furthermore comprising at least one first communication interface with at least one wide-area communication network. The management module comprises electronic circuitry configured to: on detection of a congestion of said first communication interface, determine, for each second communication interface, whether at least one station is connected to said second communication interface in question, and, for said second communication interface in question to which at least one station is connected, detect a first communication stream via said second communication interface in question, between said wide area network and said local area network, on the one hand, and a second communication stream, via said second communication interface in question, between several stations connected to said local area network, on the other hand, then: either when a first communication stream via said second communication interface in question is present, between said wide area network and said local network, or when a second communication stream, via said second communication interface in question, is present, between several stations connected to said local area network, and, if the throughput of said second communication stream is below a predetermined throughput threshold (S1), then modify an initial configuration of said second communication interface in question to reduce its energy consumption, and otherwise maintain its initial configuration.

In a particular embodiment, the management module furthermore comprises electronic circuitry configured to: perform an action of managing an energy consumption of said second communication interface in question, when no station is connected to said second communication interface in question.

In a particular embodiment, performing said action of managing an energy consumption of said second communication interface in question comprises: switching off said second communication interface in question.

According to a particular embodiment, the management module furthermore comprises electronic circuitry configured to: when said configuration of said second communication interface in question has been modified, then check whether said congestion is still detected and, when said congestion is still detected, determine whether a use of an antenna time by said second communication interface in question is greater than or equal to a predetermined antenna-time threshold, and, when said use of the antenna time by said second communication interface in question is greater than or equal to the predetermined antenna-time threshold, then restore said initial configuration of said second communication interface in question.

According to a particular embodiment, the management module furthermore comprises electronic circuitry configured to: when said configuration of said second communication interface in question has been modified, then check whether said congestion is still detected and, when said congestion is no longer detected, restore said initial configuration of said second communication interface in question.

A network gateway is also proposed here comprising at least one first interface for communication with a wide-area communication network and at least one second interface for communication to a local communication network. The network gateway comprises a management module as described previously.

A computer program product is also proposed here, comprising instructions causing the execution, by a processor, of the method as described above, when said instructions are executed by the processor.

A storage medium is also proposed here, storing a computer program comprising instructions causing the execution, by a processor, of the method as described above, when said instructions are read and executed by a processor.

### BRIEF DESCRIPTION OF THE DRAWINGS

The features of the present disclosure mentioned above, as well as others, will emerge more clearly from the reading of the following description of at least one example embodiment, said description being made in relation to the accompanying drawings, among which:

FIG. 1 illustrates schematically an example of an environment for implementing the method for managing the energy consumption of wireless communication interfaces of an access-point electronic device of the network gateway type according to a particular embodiment;

FIG. 2 illustrates schematically an example of hardware architecture of an access-point electronic device of the network gateway type according to a particular embodiment;

FIG. 3A illustrates schematically an example of hardware architecture of a wireless communication interface of an access-point electronic device of the gateway type according to a particular embodiment;

FIG. 3B illustrates schematically an example of hardware architecture of a communication interface of an access-point electronic device of the gateway type according to a particular embodiment;

FIG. 4 illustrates in diagram form steps of a method for managing the energy consumption of the wireless communication interfaces of an access-point electronic device of the gateway type according to a particular embodiment;

FIG. 5 Illustrates in diagram form steps of the method for managing the energy consumption of the wireless communication interfaces of an access-point electronic device of the gateway type according to a particular embodiment;

FIG. 6 illustrates schematically an example of hardware architecture of a module for managing the energy consumption of the wireless communication interfaces of an access-point electronic device of the network gateway type, configured to perform all or some of the steps of the management method of FIGS. 4 and 5.

### DETAILED DISCLOSURE OF EMBODIMENTS

The general principle of one or more embodiments relates to reducing the energy consumption of an access-point electronic device, such as a network gateway, via reducing the communication capacities of its wireless communication interfaces, establishing one or more wireless local communication networks. More particularly, an object of the present disclosure is reducing the communication capacities of the wireless communication interfaces of the network gateway, when a congestion is detected at a communication interface of this same gateway enabling it to be able to connect with a broadband wide area network (WAN).

A congestion, or crowding, of a communication network is the reduction in the quality of service that occurs when a node or a link in the network transports more data than it can process. The typical effects are delays in the processing of packets that accumulate in queues, losses of packets, a reduction in throughput or the blocking of new connections. There are various solutions for detecting such congestion and remedying same.

The request for comments RFC 9330 of the IETF (the acronym for “Internet Engineering Task Force”) introduces the so-called “Low Latency, Low Loss, and Scalable Throughput” technology (also known by the acronym “LAS”). LAS technology operates as a congestion control mechanism by providing feedback of information on the congestion of the bottlenecks in the network to the applications used. For this purpose, this LAS technology uses an explicit congestion notification mechanism or ECN to give an early warning about congestion at the link corresponding to a “bottleneck” by marking a “Congestion Experienced” or “CE” code point in the IP header of the packets. After having received the packets, the receiver sends this congestion information to the sender in the acknowledgment (ACK) packets of the transport protocol. The sender uses this feedback of information about congestion to reduce its rate of sending packets in order to avoid delays at the bottleneck.

According to another solution, when congestion is detected at an air interface of the radio access network of a cellular network (or “Radio Access Network” or RAN) (e.g. via the monitoring of indicators and metrics for monitoring the traffic load and the quality of service on the air interface and the transport network), the network core of a cellular network can send notifications to the user equipment (UE) such as the network gateways equipped with a UE for access to the wide area network (WAN, typically considered to be internet access), in order to limit their aggregated maximum bit rate (AMBR).

Hereinafter, “radio interfaces” means wireless communication interfaces configured to establish wireless local communication networks or WLANs (wireless local area networks) via which stations can connect together and/or access, via the network gateway, a broadband wide area communication network or WAN (wide area network). Such radio interfaces are also called WLAN radio interfaces. Access to the wide area network WAN is possible via one or more communication interfaces enabling the network gateway to be able to connect to the wide area network WAN. Such communication interfaces are hereinafter called “WAN communication interfaces”. It should be noted that the WAN communication interface may be of the wireless communication interface type.

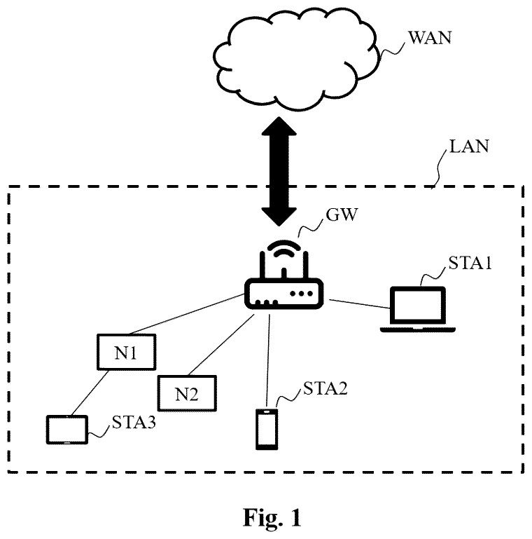

FIG. 1 thus illustrates schematically an example of an environment for implementing a method for managing the energy consumption of one or more WLAN radio interfaces of an access-point electronic device of the network gateway type, according to a particular embodiment;

FIG. 1 presents a first local communication network LAN (“Local Area Network”), denoted LAN and hereinafter referred to as local area network LAN. This local area network LAN comprises an access-point electronic device, here of the network communication gateway type, denoted GW. The network gateway GW is configured to perform mainly, but not exclusively, link and communication interface functions between the local area network LAN and a second communication network of the broadband wide area type or WAN, denoted WAN and hereinafter referred to as wide area network WAN. Such a wide area network WAN is, for example, an internet network. For this purpose, the network gateway GW comprises one or more communication interfaces WAN enabling it to be able to connect to the wide area network WAN for example via a wire connection (ADSL or fibre), or by a radio wireless link (of the cellular type, e.g. 2G to 5G as specified by one of the standards resulting from the cooperation of the “3rd Generation Partnership Project ”or “3GPP”).

The local area network LAN furthermore comprises a set of stations such as: user devices STA1, STA2, STA3 (e.g. a personal computer STA1, a smartphone STA2, a tablet STA3) and one or more access-point electronic devices forming a system for extending wireless communication coverage (for example: Wi-Fi extenders, wireless repeaters, etc, not shown). This system for extending wireless communication coverage coordinates several access points integrated in communication nodes denoted N1 and N2. These various access points are interconnected by means of a backhaul subnetwork. These access points all allow access to the local area network LAN for other stations, such as for example the user device STA3. The access points N1 and N2 can be connected to the network gateway GW by wireless link or wireless radio link for access to the wide area network WAN.

The user devices STA1, STA2, STA3 can be connected directly to the network gateway GW or via one of the access points located in the communication nodes N1 or N2 (as shown in FIG. 1). The connection with the network gateway GW or the access points located in the communication nodes N1, N2 can be made by wire connection (for example of the Ethernet type), or by other types of connection such as for example USB, wireless connection (for example of the type: Wi-Fi, Bluetooth, Bluetooth Low Energy, Zwave, Zigbee, DECT-ULE, etc.) The network gateway GW thus comprises wireless communication interfaces, or WAN radio interfaces, in order to be able to establish one or more local wireless communication networks, of the WLAN (“Wireless Local Area Network”) type and hereinafter referred to as wireless local area network WLAN (not shown in FIG. 1). Such wireless local area networks WLAN use, for example, the 802.11 technology or standard in one of the versions thereof, such as 802.11-2012, 802.11-2016 or 802.11-2020, with one or more of these amendments such as 802.11n-2009, 802.11ac-2013, 802.11ax-2021, or the provisional version of amendment P802.11be in edition D7.0 thereof. These radio interfaces are configured to implement bidirectional wireless communications between one or more compatible stations and one or more wireless local communication networks of the WLAN type (not shown in FIG. 1), thus extending the local area network LAN. Some of these radio interfaces are able to establish bidirectional wireless communications in accordance with one of the versions of the 802.11 standard in one or more frequency bands from the bands 2.4 GHz, 5 GHz and 6 GHz.

Hereinafter, the user devices STA1, STA2, STA3 and the access points located in the communication nodes N1, N2 are called “stations”. Thus the term “station” here designates any electronic and/or computing device configured to be connected at least to the communication network LAN and, where applicable, to one of the wireless communication networks WLAN. In other words, these stations are able to connect to the local area network LAN and/or to one of the wireless local area networks WLAN extending the local area network LAN, in that they have authorisations and configurations necessary for accessing the resources of said local area network LAN and/or the wireless local area networks WLAN extending the local area network LAN. Hereinafter, communications between stations in one and the same wireless local area network or to another wireless local area network via a WLAN radio interface 201, 202 are assimilated to communications between stations in the local area network LAN via a WLAN radio interface 201, 202.

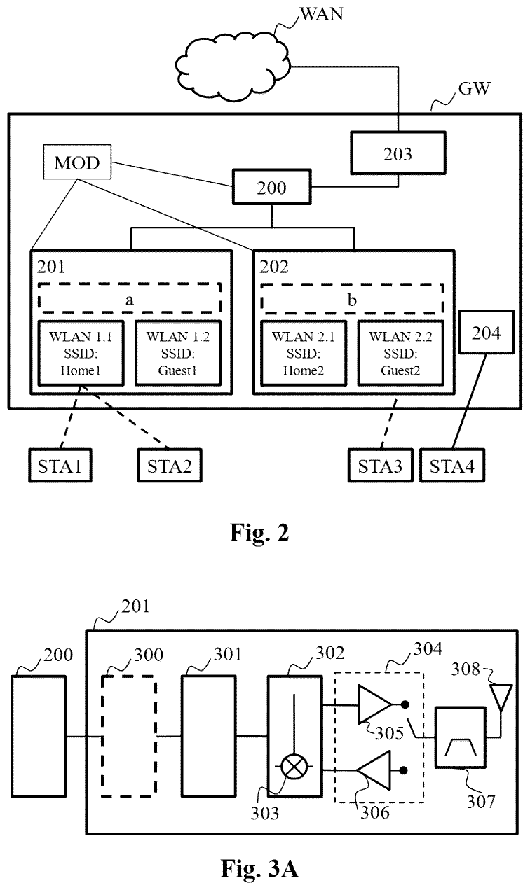

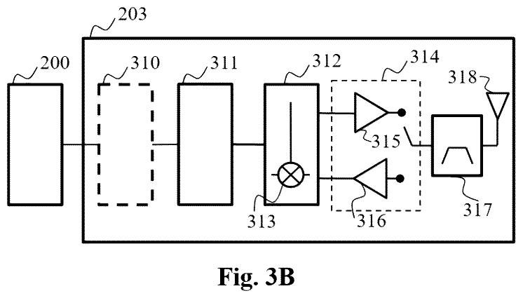

FIG. 2 illustrates schematically an example of hardware architecture of an access-point electronic device of the network gateway GW type according to a particular embodiment. The network gateway GW comprises one or more WLAN radio interfaces that can be independently activated or deactivated. In particular, according to the example in FIG. 2, the network gateway GW comprises a first WLAN radio interface 201, and a second WLAN radio interface 202. These first and second WLAN radio interfaces 201 and 202 will be described in more detail hereinafter in relation to FIG. 3A. These first and second WLAN radio interfaces 201 and 202 are configured to provide the stations STA1 to STA3 with wireless connectivity to the local area network LAN and/or to one or more wireless local communication networks WLAN extending the local area network LAN.

The respective channels on which these first and second WLAN radio interfaces 201 and 202 operate are the channels designated by “a” and “b”. These channels “a” and “b” belong to a frequency band (e.g., 2.4 GHz, 5 GHz, 6 GHZ) that is divided into several so-called operational channels on which they can operate. In a network of the IEEE 802.11 type, these channels are generally 20 MHz wide and can be aggregated in order to increase the transmission capacity of the operational channel (40 MHz, 80 MHz, 160 MHz or even 320 MHz depending on the spectrum width available in the frequency band).

According to a particular example embodiment, these first and second WLAN radio interfaces 201 and 202 are configured to provide access to one or more distinct wireless communication networks WLAN. In fact it is possible to allocate several service set identifiers SSID on one and the same WLAN radio interface (2.4 GHz or 5 GHZ). The SSID enables the stations STA1 to STA3 to identify themselves and to connect to a specific wireless local communication network WLAN. When a station STA1 to STA3 connects to a wireless local communication network WLAN, it uses among other things the SSID to identify this network.

Thus, according to the example in FIG. 2, the first WLAN radio interface 201 is configured to provide access to two distinct wireless communication networks WLAN: a first wireless communication network denoted WLAN 1.1 the SSID of which is “Homel” and a second wireless communication network denoted WLAN 1.2 the SSID of which is “Guest1”. In the same way, the second WLAN radio interface 202 is configured to provide access to two distinct wireless communication networks WLAN: a first wireless communication network denoted WLAN 2.1 the SSID of which is “Home2” and a second wireless communication network denoted WLAN 2.2 the SSID of which is “Guest2”. In the example in FIG. 2, the stations STA1 and STA2 are connected, via a Wi-Fi wireless connection, to the first wireless communication network WLAN 1.1 provided by the first WLAN radio interface 201 and the station STA3 is connected, via a Wi-Fi wireless connection, to the second wireless communication network WLAN 2.2 provided by the second WLAN radio interface 202.

The network gateway GW also comprises a communication interface 203 for access to the wide area network WAN, referred to as “WAN communication interface 203”. This WAN communication interface 203 is configured to implement bidirectional communications between the network gateway GW and the wide area network WAN. This WAN communication interface 203 is, for example, a wireless communication interface, or radio interface, enabling the network gateway GW to connect to a wide area network WAN of the cellular network type of an operator, via a radio wireless connection of the 2G to 5G type. The network gateway GW furthermore comprises a processor 200 configured to control the functionalities of the network gateway GW and to manage the various WLAN radio interfaces 201 and 202 and the WAN communication interface 203. The processor 200 is in particular configured to manage the data streams between the WLAN radio interfaces 201 and 202 and the WAN communication interface 203.

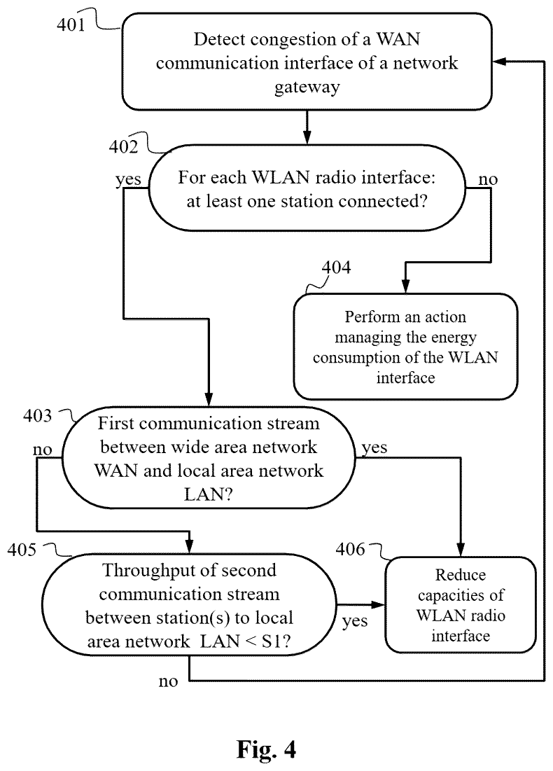

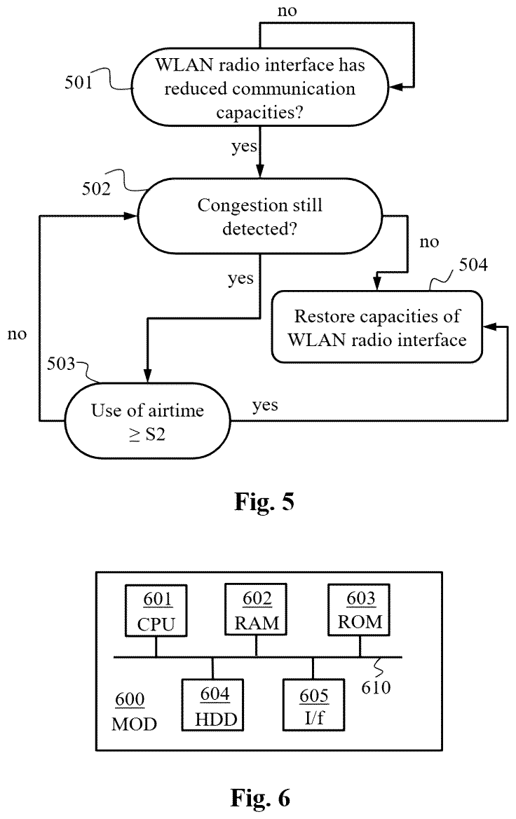

The network gateway GW furthermore comprises a module for managing the energy consumption of the WLAN radio interfaces of the network gateway GW (also hereinafter referred to as management module), denoted MOD. An example of hardware architecture of this management module MOD is described hereinafter in relation to FIG. 6. The management module MOD is configured to implement all or part of the method for managing the energy consumption of the WLAN radio interfaces of the network gateway GW described below in relation to FIGS. 4 and 5.

According to the example in FIG. 2, the network gateway GW furthermore comprises another communication interface 204 configured to provide the compatible stations with cable connectivity (e.g. Ethernet) to the local area network LAN. In the example in FIG. 2, a station STA4 is connected by cable to this other communication interface 204.

FIG. 3A and FIG. 3B schematically illustrate respectively an example of hardware architecture of a WLAN radio interface of an access-point electronic device of the gateway GW type according to a particular embodiment and an example of hardware architecture of a WLAN communication interface of an access-point electronic device of the network gateway GW type according to a particular embodiment.

According to the example in FIG. 3A, the first WLAN radio interface 201 (or the second WLAN radio interface 202) of the network gateway GW is controlled by means of the processor 200. The first WLAN radio interface 201 comprises, optionally, a dedicated processor 300 and a digital signal processing processor 301 commonly referred to as a DSP (“Digital Signal Processor”). The latter comprises a digital to analogue converter on the transmission channel and an analogue to digital converter on the reception channel. It should be noted that this dedicated processor 300 of the first WLAN radio interface 201 may be optional as distinct component according to the implementation. This is because, according to certain embodiments, its functionalities may be integrated with other components, such as the processor 200.

The analogue signals in transmission, and respectively in reception, are modulated, and respectively demodulated, by a radio-frequency modem 302 comprising a mixer 303. A front-end module 304 amplifies the transmission signal (power amplifier 305), while the reception signal is amplified by a low-noise converter unit 306. A filter 307 switchable between the transmission channel and the reception channel is interposed between the output of the power amplifier 305 and the antenna 308 on the one hand and the input of the low-noise converter unit 306 and the antenna 308 on the other hand.

The embodiment in FIG. 3A illustrates the case where the first WLAN radio interface 201 (or the second WLAN radio interface 202) comprises a single transmission/reception chain, however a radio interface may comprise several transmission/reception chains. Certain components may be common to several chains, for example the processor 300 or the digital signal processor 301.

According to the example in FIG. 3B, like the first WLAN radio interface 201 (or the second WLAN radio interface 202), the WAN communication interface 203 of the network gateway GW is controlled by means of the processor 200. The WAN communication interface 203 comprises, optionally, a dedicated processor 310 and a digital signal processing processor 311 commonly referred to as a DSP (“Digital Signal Processor”). The latter comprises a digital to analogue converter on the transmission channel and an analogue to digital converter on the reception channel. It should be noted that this dedicated processor 310 of the first WAN communication interface 203 may be optional as distinct component according to the implementation. This is because, according to certain embodiments, its functionalities may be integrated with other components, such as the processor 200.

The analogue signals in transmission, and respectively in reception, are modulated, and respectively demodulated, by a radio-frequency modem 312 comprising a mixer 313. A front-end module 314 amplifies the transmission signal (power amplifier 315), while the reception signal is amplified by a low-noise converter unit 316. A filter 317 switchable between the transmission channel and the reception channel is interposed between the output of the power amplifier 315 and the antenna 318 on the one hand and the input of the low-noise converter unit 316 and the antenna 318 on the other hand.

The embodiment in FIG. 3B illustrates the case where the WAN communication interface 203 comprises a single transmission/reception chain, it may comprise several transmission/reception chains. Certain components may be common to several chains, for example the processor 310 or the digital signal processor 311.

FIG. 4 shows in diagram form the steps of the method for managing the energy consumption of the WLAN radio interfaces 201, 202 according to one embodiment. All or part of this method is implemented by the management module MOD described below in relation to FIG. 6.

During a step 401, the management module MOD detects congestion on the WAN communication interface 203 of the network gateway GW. This congestion on the WAN communication interface 203 corresponds to the fact that this WAN communication interface 203 is transporting more data than it can process. In other words, it suffers delays in the queues and/or losses of packets, etc

For this purpose, the management module MOD obtains so-called “congestion information” according to which the WAN communication interface 203 of the network gateway GW suffers congestion.

According to one embodiment, when the WAN communication interface 203 of the network gateway GW uses a high-throughput cellular wireless connection (of the 4G to 5G type) and congestion on said communication interface is detected, this congestion is then announced to the network gateway GW, for example via the sending, by an entity of the cellular network, to the network gateway GW, of a notification to reduce the value of the AMBR by the core of the network with respect to the value normally received by the network core (a value that can be defined for example by averaging over time (e.g. over a day, over a week, etc) AMBR values previously received). According to this example, the congestion information can therefore be obtained by the management module MOD from the notification to reduce the value of the AMBR sent by the network core to the network gateway GW. More particularly, in a conventional manner, the processor 200 of the network gateway GW receives the notification to reduce the value of the AMBR via a management module configured to manage the WAN communication interface 203. Thus, according to one embodiment, this notification is next transferred by the processor 200 to the management module MOD, which then detects that congestion on the WAN communication interface 203 is present. It should be noted that, in this example, it is considered that the WAN communication interface of the network gateway GW is of the radio type (e.g. 4G or 5G) and is therefore compatible with receiving notifications to reduce the value of the AMBR. In one example, the WAN communication interface 203 of the network gateway GW receives, from the cellular network, the notification to reduce the value of the AMBR at the time of reception by the network gateway GW of a request to establish the context of the user equipment, or “UE context setup request”, comprising a parameter indicating the value of the AMBR. In another example, this notification to reduce the value of the AMBR is received by the network gateway GW through a message, coming from the cellular network, of a request to create a logical communication channel for a given service, or “bearer setup request”. In yet another example, a message of the type “RRC Connection Reconfiguration”, to modify a “UE context” or a “bearer context”, is used to notify the reduction of the value of the AMBR. This message may furthermore comprise a certain other quality of service “QoS” parameters, such as the parameter Guaranteed Bit Rate “GBR”, or the parameter Maximum Bit Rate “MBR”.

According to another embodiment, alternatively or additionally, the congestion information is obtained from an analysis of the IP headers of the packets intended for a station connected to the wireless local communication network WLAN. More particularly, the management module MOD obtains the congestion information after having analysed the IP headers of the packets intended for the WLAN radio interfaces 201 and 202. This analysis comprises in particular: receiving packets coming from the wide area network WAN and intended for a station connected to the wireless local communication network WLAN, and detecting that an IP header of the packets comprises a code point “Congestion Experienced” (or CE).

In a variant, the management module MOD obtains the congestion information from a congestion notification indicating that the WAN communication interface 203 is suffering congestion. This congestion notification is transmitted to the management module MOD, for example by a so-called “congestion module” of the network gateway GW configured to analyse the IP headers of the packets intended for the WLAN radio interfaces 201 and 202. This is because, when the network gateway GW is compatible with the LAS technology described previously, the latter are can, where applicable, ark the IP headers of all the packets coming from the wide area network WAN and intended for all the stations connected in the local communication network LAN via the LAS mechanism to indicate congestion in a case where some of the stations are compatible with this LAS mechanism. The compatible stations will then be responsible for themselves reducing the quantities of information to be transmitted in order to favour solely critical streams.

Consequently, when congestion on the WAN communication interface 203 is detected, it may be advantageous to reduce the capacities of the WLAN radio interfaces 201 and 202 in order to save energy. This is because, since the WAN communication interface 203 is temporarily limited in terms of communication capacities because of the congestion, it is then not necessary to operate the WLAN radio interfaces 201 and 202 at the maximum of their communication capacities. Very often, the communication capacities in the local area network LAN are greater than the communication capacities of the wide area network WLAN (maximum achievable theoretical throughput).

During a step 402, in the case of congestion on the WAN communication interface 203 (i.e. the management module MOD has obtained congestion information), for each WLAN radio interface 201 and 202, the management module MOD determines whether at least one station is connected to the WLAN radio interface 201, 202 concerned.

According to one example embodiment, the management module MOD determines whether at least one station is connected to the WLAN radio interface 201, 202 concerned by itself detecting whether at least one station is connected to said WLAN radio interface 201 or 202. In a variant embodiment, the management module MOD determines whether at least one station is connected to the WLAN radio interface 201, 202 concerned by receiving a connection notification. This connection notification indicates whether one or more stations are connected to said WLAN radio interface 201 or 202 or whether no station is connected to said WLAN radio interface 201 or 202. The management module MOD receives this connection notification from a so-called “connection module” of the gateway GW configured to determine whether stations are connected to said WLAN radio interface 201 or 202 for example.

If no station is connected to the WLAN radio interface 201, 202 in question (response “no” at the end of the step 402), the management module MOD undertakes, in the step 404, an action with respect to the WLAN radio interface 201, 202 in question. Advantageously this action undertaken, referred to as “energy consumption management action”, relates to the energy consumption of the WLAN radio interface 201, 202.

In a preferred embodiment, if no station is connected to the WLAN radio interface 201, 202 in question (response “no” at the end of the step 402), the energy consumption management action undertaken by the management module MOD is to switch off (step 404) the WLAN radio interface 201, 202 in question. For this purpose, the management module MOD transmits, to the WLAN radio interface 201, 202 concerned, a first so-called “switch-off message” indicating that it must switch off.

In another embodiment, if no station is connected to the WLAN radio interface 201, 202 in question (response “no” at the end of the step 402), the energy consumption management action undertaken by the management module MOD is a combination of one or more of the capacity reductions as described in relation to the step 406 described above, such as for example:
reducing the width of the operational channel of the WLAN radio interface 201, 202,
reducing the number of transmission chains of the WLAN radio interface 201, 202,
reducing the number of reception chains of the WLAN radio interface 201, 202,
reducing the total transmission power of the WLAN radio interface 201, 202,
increasing the periodicity of sending the beacon frames.

In another embodiment, if no station is connected to the WLAN radio interface 201, 202 in question (response “no” at the end of the step 402), the action undertaken after this first iteration by the management module MOD is to reiterate, with or without time delay, the detection of a congestion on the interface via the step 401. If, at the end of this new iteration of the steps in FIG. 4, congestion is once again detected, then one or more actions in relation to the energy consumption of the WLAN radio interface 201, 202 can be undertaken. Advantageously, the first iteration makes it possible not to undertake any action when the congestion detected has been brief and is no longer detected at the second iteration.

On detection of congestion, the congestion module MOD checks whether the congestion is still present.

For this purpose, according to one embodiment, the management module MOD checks whether, at the end of a predetermined period, it is still detecting the previously detected congestion, i.e. it obtains new congestion information). Thus, as long as the management module MOD detects the congestion, the switching off of the WLAN radio interface 201, 202 is maintained. On the other hand, if at the end of the predetermined period the management module MOD no longer detects any congestion (i.e. it does not obtain new congestion information), the nominal operation mode of the WLAN radio interface 201, 202 is re-established.

According to another embodiment, alternatively or additionally, the management module MOD checks whether it has received an end-of-congestion notification indicating that the previously detected congestion has ended. In one example, this notification is sent by the network core and is received by the processor 200 of the network gateway GW, which then transmits this end-of-congestion notification to the management module MOD. Alternatively, or additionally, this end-of-congestion notification is transmitted to the management module MOD by a congestion module of the network gateway GW configured to analyse the IP headers of the packets intended for the WLAN radio interfaces 201 and 202.

If at least one station is connected to the WLAN radio interface 201, 202 in question (response “yes” at the end of the step 402), during a step 403 the management module MOD determines whether a first communication stream between the WLAN radio interface 201, 202 and the WAN communication interface 203 of the network gateway GW is present (i.e. one or more stations of the local area network LAN are accessing the wide area network WAN). The term “communication stream” means here the movement of data packets from one station to another on the local communication network LAN and/or from a station to the wide area network WAN.

For this purpose, according to one example, the management module MOD detects whether a first communication stream via the WLAN radio interface 201, 202 between stations in the local area network LAN and the WAN communication interface 203, for access to the wide area network WAN, is present. In a variant, the management module MOD determines whether this first communication stream is present by receiving a notification of first communication stream indicating an absence or presence of this first communication stream. The management module MOD receives this notification of first communication stream from a so-called “first communication stream module” of the gateway GW configured to determine whether this first communication stream is present or absent.

If a first communication stream is present (response “yes” at the end of the step 403) then, during a step 406, the management module MOD modifies a configuration of the WLAN radio interface 201, 202 in question. “Configuration” means the configuration of the operational channels and/or the number of transmission/reception chains of the WLAN radio interface and/or the transmission power of the WLAN radio interface. This configuration modification consists in reducing the communication capacities of the WLAN radio interface 201, 202 in question, according to one or other or a combination of the reduction criteria described below. For this purpose, the management module MOD transmits, to the WLAN radio interface 201, 202 concerned, a second so-called “communication capacities reduction message” indicating that it must reduce its communication capacities. This second message comprises, for example, an indication concerning the reduction criterion or criteria to be fulfilled. This makes it possible not only to reduce the energy consumption of the WLAN radio interface 201, 202, but also to remedy the problem of congestion of the WAN communication interface 203, by reducing the network traffic arriving towards this interface. If there is no first communication stream (response “no” at the end of the step 403), then, during a step 405, the management module MOD determines whether there is a second communication stream via the radio interface 201, 202 in question, to the local communication network LAN, for example in the form of a data stream mutually between one or more stations.

For this purpose, according to one example, the management module MOD detects whether a second communication stream mutually between one or more stations on the local area network LAN via the WLAN radio interface 201, 202 in question is present. In a variant, the management module MOD determines whether there is a second communication stream via the radio interface 201, 202 in question to the local communication network LAN by receiving a notification of second communication stream indicating that a second communication stream in the local area network LAN via the WLAN radio interface 201, 202 in question is present or absent. The management module MOD receives this notification of second communication stream from a so-called “second communication stream module” of the gateway GW configured to determine whether a second communication stream in the local area network LAN via the WLAN radio interface 201, 202 in question is present or absent.

If a second communication stream is present, the management module MOD measures the throughput of this second communication stream. If this throughput of the second communication stream is below a predetermined first threshold, referred to as throughput “threshold”, denoted S1 (response “yes” at the end of the step 405), then the management module MOD modifies the configuration of the WLAN radio interface 201, 202 in question by reducing the communication capacities thereof during the step 406. This predetermined throughput threshold S1 is for example 50 Mpbs passing through the wireless local communication network WLAN via a 5 GHz WLAN radio interface with four transmission and reception antennas, the theoretical throughput of which may be as much as 4.8 Gbps. This makes it possible to support a video with 4K and 60fps resolution. In another example, the predetermined throughput threshold S1 is 10 Mbps to support a video with HD resolution or 20 Mbps to support a video with 4K resolution.

In other words, if there is no second communication stream using a WLAN radio interface 201, 202 or if the throughput of the second communication stream is below the first predetermined threshold S1 (i.e. packets passing via said WLAN radio interface 201, 202 would support a reduction in communication capacities of said WLAN radio interface 201, 202), then it is possible to reduce the communication capacities of said WLAN radio interface 201, 202 according to the various reduction criteria described below, in order to limit the consumption due to this WLAN radio interface 201, 202, for the time that the congestion is no longer detected (i.e. the time during which the management module does not obtain any congestion information at the end of the predetermined period).

On the other hand, if the throughput of the second communication stream is greater than or equal to the first predetermined threshold S1 (response “no” at the end of the step 405), then the management module MOD begins a time delay before reiterating the steps of the management method as described above. The term “time delay” defines a minimum period to wait before reiterating the management method as described above.

As mentioned previously, reducing the communication capacities of one or other of the WLAN radio interfaces 201, 202 in question, or both, can be done according to one or other or a combination of the reduction criteria described below.

It should be noted that, if the management module MOD does not detect congestion of the WAN communication interface 203, then the configuration of the WLAN radio interface 201, 202 in question remains unchanged.

A first reduction criterion is the reduction of the operational channel width (e.g. typically, for a radio interface operating on the 5 or 6 GHz band: changing from 160 MHz to 40 MHZ, or even 20 MHz). In this case, the width of the operational channel being used by the WLAN radio interface 201, 202 is broadcast in a beacon, in a particular in a field of the “information element” type (e.g. “VHT Operation element”, “HE Operation element”, “EHT Operation element”, etc). This is because, when a radio interface is activated, in a network of the IEEE 802.11 type, it sends beacons periodically or on demand via the sending of a response frame (“probe response”) if a probe request has been received. The “Information Element” then indicates the future change in operational channel. This “Information Element” comprises a counter that is decremented at each beacon and, when it arrives at 0, the operational-channel change takes place.

Alternatively, this “Information Element” indicating this change in operational channel can also be sent via a management frame (“(Robust) Public Action Frame” as defined in IEEE 802.11-2020) spontaneously in order to warn the stations without having to wait until they receive the beacon.

Alternatively, any modification to this operational-channel width, increasing or decreasing, can be done conventionally via the use of an extended channel change message (“Channel Switch Announcement” or CSA) indicating the new channel width. This is because a message of the CSA type, as defined by IEEE 802.11h, enables a radio interface to announce that it is passing to a new channel before beginning to transmit on this channel. This message can be included in the beacon (with a countdown indicating when the operational-channel change will take place) and/or sent by broadcast via a supplementary management frame.

Apart from the reduction in maximum throughput offered (i.e. bandwidth) on said WLAN radio interface 201, 202 and therefore by means of the reduction in congestion on the WAN communication interface 203, this has the effect of limiting the energy consumption of said WLAN radio interface 201, 202 (fewer processing operations/calculations to be performed since there is less data to be processed). Advantageously, reducing the bandwidth has no impact on the range of a WLAN radio interface, in particular in the case of stations a little distant from the network gateway GW. This is because limiting the bandwidth of a system with constant total transmission power makes it possible to improve the power of each subcarrier in an orthogonal frequency-division multiplexing (OFTM) system and therefore the signal-to-noise ratio at the receiver.

A second reduction criterion is the reduction in the number of transmission chains (e.g. typically for a radio interface: changing from four transmission antennas to two transmission antennas, or even one transmission antenna). This reduction in the number of transmission chains can be done, in a conventional manner, via the use of an information element of the OMI/OMN (“Operation Modification Indication” or “Operation Modification Notification”) type as defined by amendment 802.11 ax or 802.11 ac of the IEEE 802.11 protocol. This “Information Element” of the OMI/OMN type indicates to the stations the maximum number of spatial streams supported in transmission and/or reception. It should be noted that it is not possible to have more spatial streams than antennas. It is thus possible for the WLAN radio interface the communication capacities of which are reduced to warn the stations of these changes, which will be broadcast in the “Information Element” field of the beacon (e.g. “Supported VHT-MCS and NSS Set” field in the “Information Element” of the “HT Operation” type).

Apart from the reduction in maximum throughput offered on said WLAN radio interface 201, 202 and therefore by means of the reduction in congestion on the WAN communication interface 203, this has the effect of reducing the number of power amplifiers 305 to be supplied, a power amplifier 305 being associated with a transmission chain, and therefore reducing the energy consumption of said WLAN radio interface 201, 202 (these power amplifiers 305 being significant sources of consumption in the front-end modules 304, especially on the high 5 GHZ/ 6 GHz bands).

A third reduction criterion is the reduction in the number of reception chains, which has the effect of reducing the reception operations (even if they are less expensive in terms of energy than the transmission operations). This reduction in the number of reception chains can be done in the same manner as for the reduction in the transmission chains described above.

However, this reduction in the number of reception chains may cause losses of connection of stations a little distant from the network gateway GW since less reception diversity is present. According to one embodiment, to overcome this drawback, this reduction in the number of reception chains is done according to the reception power level (or according to the acronym RSSI, standing for “Received Signal Strength Indicator”) of the stations associated with this WLAN radio interface 201, 202. For example, typically in Wi-Fi for a WLAN radio interface 201, 202 having four reception antennas, if:
no station is connected to said WLAN radio interface 201, 202 with a reception power level below −75 dBm, then the number of reception antennas of said WLAN radio interface 201, 202 will decrease to 1,
no station is connected to said WLAN radio interface 201, 202 with a reception power level below −80 dBm and at least one station is connected to said WLAN radio interface 201, 202 with a reception power level of between −75 and −80 dBm,, then the number of reception antennas of said WLAN radio interface 201, 202 will decrease to 2,
at least one station is connected to said WLAN radio interface 201, 202 with a reception power level below −80 dBm, then the number of reception antennas of said WLAN radio interface 201, 202 is not changed and remains at four.

A fourth reduction criterion is the reduction in the total transmission power of the WLAN radio interface 201, 202 (e.g. changing from 30 dBm to 23 dBm). Apart from the reduction in maximum throughput offered on said WLAN radio interface 201, 202 and therefore by means of the reduction in congestion on the WAN communication interface 203, this has the effect of reducing the power level necessary to be applied to the power amplifiers 305, a power amplifier 305 being associated with a transmission chain, and therefore reducing the energy consumption of said WLAN radio interface 201, 202 (these power amplifiers 305 being significant sources of consumption in the front-end modules 304, especially on the high 5 GHz/ 6 GHz bands).

According to one embodiment, when the management module MOD must reduce the communication capacities of at least two WLAN radio interfaces 201 and 202, then a mechanism for prioritising the reduction in the communication capacities is used. More particularly, reducing the communication capacities of a radio interface depends on the frequency band on which it is operating. This is because the higher the frequency band used by the radio interface, the more energy it uses. For example, if the first WLAN radio interface 201 is an interface operating at 6 GHz, then it uses more energy than the second WLAN radio interface 202 operating at 2.4 GHz. Thus, if at least one station is connected to each of the WLAN radio interfaces 201 and 202, then, during the step 406, the management module MOD first of all compares the frequency bands used of the first and second WLAN radio interfaces 201 and 202 with each other. Then the management module MOD implements the reduction in the communication capacities first for the radio interface the frequency band of which is the highest (e.g. first interface operating at 6 GHz) among the WLAN radio interfaces (e.g. second WLAN radio interface 202 operating at 2.4 GHz). In other words, the management module MOD reduces the communication capacities of the WLAN radio interfaces that are using the most energy as a priority with respect to the WLAN radio interfaces using less energy.

It should be noted that reducing the communication capacities of the radio interface operating on the highest frequency band may be sufficient if an energy-saving criterion (e.g. number of watts to be saved) is associated with this method, and therefore that there is no need to reduce the communication capacities of the radio interfaces the frequency band of which is smaller.

FIG. 5 illustrates in diagram form other steps of the method for managing the energy consumption of the WLAN radio interfaces 201, 202 according to one particular embodiment.

In the case of saturation of one or other of the first or second WLAN radio interfaces 201, 202 during a predetermined period (e.g. because of an excessively great reduction in the communication capacities of said WLAN radio interface, without however leading to its being switched off), the communication capacities of said WLAN radio interface 201, 202 are gradually restored. A saturation criterion is then defined corresponding to a second predetermined threshold, denoted S2, referred to as antenna-time or “airtime” threshold (i.e. the amount of time used by a radio interface for communicating (transmitting and receiving) and expressed as a percentage of the observation time), to be exceeded over a predetermined observation period for restoring the communication capacities of the WLAN radio interfaces 201, 202.

For example, if the transmissions and/or receptions of the WLAN radio interface 201, 202 the communication capacities of which have been reduced are above the predetermined airtime threshold S2, for example at 70% of the airtime over an observation period of five seconds, then it may be judicious to cancel one or other or a combination of the previous reductions in communication capacities (i.e. reducing the number of transmission and/or reception chains and/or decreasing the operational channel and/or decreasing the transmission power) until this saturation criterion is no longer met.

Thus, during a step 501, the management module MOD determines, for each WLAN radio interface 201 and 202, whether it has had its communication capacities reduced following the detection of the congestion.

If the WLAN radio interface 201, 202 in question has reduced capacities (response “yes” at the end of the step 501), then, during a step 502, the management module MOD checks whether the congestion detected is still present. For this purpose, according to one embodiment, the management module MOD checks at the end of a predetermined period whether it obtains new congestion information. If at the end of this predetermined period the management module MOD does not obtain any congestion information (response “no” at the end of the step 502), then the management module MOD detects that there is no longer any congestion and the initial configuration of the WLAN radio interface 201, 202 which has been modified (i.e. reduction in communication capacities) is restored during a step 504. For this purpose, the management module MOD transmits, to the WLAN radio interface 201, 202 concerned, a message re-establishing the initial configuration. This message comprises, for example, an indication that one or other or a combination of the reduction criteria used must be cancelled.

According to another embodiment, as described previously, alternatively or additionally, the management module MOD checks whether it has received an end-of-congestion notification indicating that the previously detected congestion has ended. Advantageously, receiving an end-of-congestion notification makes it possible to dispense with a time counter.

If on the other hand the management module MOD obtains, at the end of the predetermined period, new congestion information (i.e. there is still congestion) (response “yes” at the end of the step 502) and/or if it receives an end-of-congestion notification, then, during a step 503, the management module MOD determines whether the saturation criterion is met, i.e. whether the use of the antenna time or “airtime” by the WLAN radio interface 201, 202 in question is greater than or equal to the predetermined antenna-time threshold S2.

If the use of the “airtime” by the WLAN radio interface 201, 202 in question is greater than or equal to the predetermined antenna-time threshold S2 (response “yes” at the end of the step 503), then the management module MOD performs the step 504 and restores the initial configuration of the WLAN radio interface 201, 202.

If the use of the “airtime” by the WLAN radio interface 201, 202 in question is less than the predetermined antenna-time threshold S2 (response “no” at the end of the step 503), then the management module MOD reiterates the step 502.

FIG. 6 illustrates schematically the hardware architecture of a management module MOD configured to perform all or some of the steps of the management method illustrated in FIGS. 4 and 5.

The management module MOD 600 comprises, connected by a communication bus 610, one or more of the following elements: a processor or CPU (“Central Processing Unit”) 601; a random access memory RAM 602; a read-only memory ROM 603, for example a flash memory; a data storage device, such as a hard disk drive HDD, or a storage medium reader, such as an SD (“Secure Digital”) card reader 604; at least one communication interface I/f 605 enabling the management module MOD 602 interact with the processor 200 of the network gateway GW and the WLAN radio interfaces 201 and 202. In a particular embodiment, the communication interface I/f 605 enables the management module MOD to interact with a congestion module and/or a connection module and/or a first communication stream module and/or a second communication stream module.

The processor 601 is capable of executing instructions loaded in the RAM 602 from the ROM 603, from an external memory (not shown), from the data storage device 604, such as an SD card, or from a communication network (not shown). When the management module 600 is powered up, the processor 601 is capable of reading instructions from the RAM 602 and executing them. These instructions form a computer program causing the implementation, by the processor 601, of the behaviours, steps and algorithms described here, in particular in combination with all or some of the steps in FIGS. 4 and/or 5.

All or some of the behaviours, steps and algorithm described here can thus be implemented in software form by executing a set of instructions by a programmable machine, such as a DSP (“digital signal processor”) or a microcontroller, or be implemented in hardware form by a machine or a dedicated component (“chip”) or a dedicated set of components (“chipset”), such as an FPGA (“field-programmable gate array”) or an ASIC (“application-specific integrated circuit”). In general terms, the management module 600 comprises electronic circuitry arranged and configured to implement the behaviours, steps and algorithms described here.

It should be noted that the term “module” may correspond both to a software component and to a hardware component or a set of hardware and software components, a software component itself corresponding to one or more computer programs or sub-programs or more generally to any elements of a program able to fulfil a function or a set of functions.

1. A method for managing an energy consumption of a network gateway comprising at least one first interface for communication with a wide-area communication network and at least one second interface for communication to a local communication network, said management method comprising:
on detection of a congestion of said first communication interface, determining, for each second communication interface, whether at least one station is connected to said second communication interface in question, and, for said second communication interface in question to which at least one station is connected, detecting a first communication stream via said second communication interface in question, between said wide area network and said local area network, on the one hand, and a second communication stream, via said second communication interface in question, between several stations connected to said local area network, on the other hand, then:
either when a first communication stream via said second communication interface in question is present, between said wide area network and said local area network, or when a second communication stream, via said second communication interface in question, is present, between several stations connected to said local area network, and, if the throughput of said second communication stream is below a predetermined throughput threshold, then modifying an initial configuration of said second communication interface in question to reduce its energy consumption, and otherwise maintaining its initial configuration.

2. The method according to claim 1, further comprising:
performing an action of managing an energy consumption of said second communication interface in question, when no station is connected to said second communication interface in question.

3. The method according to claim 2, wherein performing said action of managing an energy consumption of said second communication interface in question comprises: switching off said second communication interface in question.

4. The method according to claim 1, furthermore comprising:
when said configuration of said second communication interface in question has been modified, then checking whether said congestion is still detected and, when said congestion is still detected, determining whether a use of an antenna time by said second communication interface in question is greater than or equal to a predetermined antenna-time threshold, and, when said use of the antenna time by said second communication interface in question is greater than or equal to the predetermined antenna-time threshold, then restoring said initial configuration of said second communication interface in question.

5. The method according to claim 1, furthermore comprising:
when said configuration of said second communication interface in question has been modified, then checking whether said congestion is still detected and, when said congestion is no longer detected, restoring said initial configuration of said second communication interface in question.

6. The method according to claim 1, wherein modifying an initial configuration of said second communication interface in question comprises:
comparing a frequency band on which said second communication interface in question is operating with a frequency band on which at least one other second communication interface is operating, and, if said frequency band on which said second communication interface in question is operating is higher than said frequency band on which said at least one other second communication interface is operating, then modifying the initial configuration of said second communication interface in question as a priority, otherwise modifying an initial configuration of said other second communication interface as a priority.

7. The method according to claim 1, wherein modifying an initial configuration of said second communication interface in question comprises one or other or a combination more of the following modifications:
reducing a width of an operational channel of said second communication interface in question,
reducing a number of transmission chains of said second communication interface in question,
reducing a number of reception chains of said second communication interface in question,
reducing a transmission power of said second communication interface in question.

8. A module for managing an energy consumption of at least one second communication interface to a local communication network of a network gateway, said network gateway furthermore comprising at least one first communication interface with a wide-area communication network, said management module comprising electronic circuitry configured to:
on detection of a congestion of said first communication interface, determine, for each second communication interface, whether at least one station is connected to said second communication interface in question, and, for said second communication interface in question to which at least one station is connected, detect a first communication stream via said second communication interface in question, between said wide area network and said local area network, on the one hand, and a second communication stream, via said second communication interface in question, between several stations connected to said local area network,
on the other hand, then:
either when a first communication stream via said second communication interface in question is present, between said wide area network and said local area network, or when a second communication stream, via said second communication interface in question, is present, between several stations connected to said local area network, and, if the throughput of said second communication stream is below a predetermined throughput threshold, then modify an initial configuration of said second communication interface in question to reduce its energy consumption, and otherwise maintain its initial configuration.

9. The management module according to claim 8, furthermore comprising electronic circuitry configured to:
perform an action of managing an energy consumption of said second communication interface in question, when no station is connected to said second communication interface in question.

10. The management module according to claim 9, wherein performing said action of managing an energy consumption of said second communication interface in question comprises: switching off said second communication interface in question.

11. The management module according to claim 8, furthermore comprising electronic circuitry configured to:
when said configuration of said second communication interface in question has been modified, then check whether said congestion is still detected and, when said congestion is still detected, determine whether a use of an antenna time by said second communication interface in question is greater than or equal to a predetermined antenna-time threshold, and, when said use of the antenna time by said second communication interface in question is greater than or equal to the predetermined antenna-time threshold, then restore said initial configuration of said second communication interface in question.

12. The management module according to claim 8, further comprising electronic circuitry configured to:
when said configuration of said second communication interface in question has been modified, then check whether said congestion is still detected and, when said congestion is no longer detected, restore said initial configuration of said second communication interface in question.

13. A network gateway comprising at least one first interface for communication with a wide-area communication network and at least one second interface for communication to a local communication network, said network gateway comprising a management module according to claim 8.

14. (canceled)

15. A non-transitory storage medium, storing a computer program comprising instructions causing the execution, by a processor, of the method according to claim 1, when said instructions are read and executed by the processor.
